(19) United States
(12) Patent Application Publication
(10) Pub. No.: US 2005/0048178 A1
(43) Pub. Date: Mar. 3, 2005

(54) Flow distributor device for an extruder

(75) Inventors: David Alexander, Wodonga (AU); Kevin Rees, Wodonga (AU)

Correspondence Address: FULBRIGHT & JAWORSKI, LLP, 1301 MCKINNEY, SUITE 5100, HOUSTON, TX, 77010-3095, US

(73) Assignee: MARS INCORPORATED, McLean, VA (US)

(21) Appl. No.: 10/927,977

(22) Filed: Aug. 27, 2004

(30) Foreign Application Priority Data
Aug. 29, 2003 (AU) 2003904709

(51) Int. Cl. A23G 1/00

(52) U.S. Cl. 426/516

(57) ABSTRACT

An extruder exit flow distribution device, for use in the transfer of high-moisture food extrudate material from an extruder, said extruder having one or more extrusion screws, to the inlet of a multi-channel cooling die, said flow distribution device having an internal extrudate passage which defines a flow path for any given element of extrudate passing from the extruder exit to the entrance of said cooling die.

### CROSS-REFERENCE TO RELATED APPLICATIONS

This application claims priority to Australian Application No. 2003904709 filed Aug. 29, 2003.

### TECHNICAL FIELD

This invention relates to cooling dies and their use in association with food extruders in the manufacture of texturised protein food products, and to a flow distribution device which may be used to direct flow from the outlet of a food extruder to the inlet of a multi-channel cooling die. In particular, this invention relates to a device which is designed to improve the efficiency of operation of the cooling die and which also acts to promote an even distribution of extrudate flow in each of the channels of the cooling die.

### BACKGROUND OF THE INVENTION

In the field of commercial food manufacture, in particular in the field of commercial pet food manufacture, it is often desired to produce a low-cost meat analogue for inclusion in a food matrix, in order to ensure that the food has an authentic “meaty” appearance, without incurring the high raw material cost associated with muscle meat. A particularly effective process for producing such meat analogues is disclosed in Patent Document No. WO 00/69276, by Effem Foods Pty Ltd. The process there described involves the use of a cooling die to effect gradual solidification of a high-moisture, protein-based extrudate, thereby creating a “fibrous” internal texture.

Of course, a limitation to the commercial usage of cooling dies in high moisture extrusion applications has been that such cooling dies tend not to be able to cope with the higher extrudate flow rates that are required when making a commercially viable food product, for example in excess of 200 kg of product per hour per extrusion unit.

In order to overcome this problem, it has therefore become necessary to improve the overall efficiency of extrudate cooling dies. One such improved design is disclosed in Patent Document No. WO 01/49474, by Effem Foods Pty Ltd. This document discloses a multi-channel cooling die which is capable of producing a texturised, high moisture extrudate at overall mass flow rates around one tonne per hour per extrusion unit.

However, one potential problem arises with multi-channel cooling dies where a single product stream exiting the extruder is split into a multitude of individual flow streams upon entry into the cooling die. The product quality achievable in each of the extrudate cooling channels depends to a large extent on ensuring a relatively even distribution of flow rates between and within each of the individual channels. In operation of a multi-channel die manufactured in accordance with WO 01/49474, it has been noted that variations in the extrudate flow rate passing through each of the individual channels of the cooling die may tend to vary, particularly during high flow rate operations.

It is suggested in Document No. WO 01/49474 that, where even flow distribution among the channels is critical, it may be beneficial to place some form of flow-restriction device in between the extruder outlet and the cooling die inlet. The intention is to produce a pressure-drop across this transition. Therefore, if the pressure restriction device features channels which are aligned precisely with cooling die channels and which present identical restrictions to flow at each channel, the flow of extrudate passing through each channel of the flow restriction device will be practically identical, thereby promoting relatively even flow in each of the cooling die channels.

However, a drawback with such a system is that extrudate material of the kind required for the production of some commercial pet food products will tend to begin solidifying upon leaving the extruder. As laminar, unidirectional flow is desirable during this solidification process in order to produce the target internal structure, forcing such partly solidified material through a flow restriction will tend to disrupt the structures already formed and to introduce turbulent flow into the still-liquid component of the extrudate. This destroys the structures already formed, which then must be reformed in order to obtain the desired laminar internal texture.

An obvious solution to this problem is to ensure that the temperature of the extrudate leaving the extruder is at a sufficiently high level, for example 180° C., such that it will not commence partial solidification until it has passed through the restriction and has settled into relatively laminar flow inside the body of the cooling die. However, such a solution is of relatively limited practical advantage in that, of course, presenting the cooling die with feed stock of considerably elevated temperature greatly increases the required cooling duty of the cooling die. This in turn will reduce the maximum flow rate which may be processed by the cooling die whilst still providing product of acceptable quality, which would tend to defeat the purpose of providing a cooling die of increased efficiency.

In addition, the heating of the extrudate to more elevated temperatures than strictly necessary for extrusion processing will tend to cause localised burning of the product.

Therefore, it is an object of the present invention to provide a device or arrangement that enables a modified extrudate flow path in between a food extruder and a multi-channel cooling die which assists in improving the efficiency of production of material via the extruder and cooling die system. It is a further object of the invention to provide a modified extrudate flow path that assists in promoting even flow-distribution amongst all of the cooling die channels.

### BRIEF SUMMARY OF THE INVENTION

According to one aspect of the invention, there is provided an extruder exit flow distribution device, for use in the transfer of high-moisture food extrudate material from an extruder, which has one or more extrusion screws, to the inlet of a multi-channel cooling die, said device having an internal extrudate passage defining a flow path for any given element of extrudate passing from the extruder exit to the entrance of said cooling die, wherein the ratio of said extrudate flow path length through said passage, to the length of the outer diameter of any one of the individual extruder screws, is greater than or equal to about 0.75:1. Preferably, the ratio is greater than about 1.2:1, and even more preferably greater than about 1.7:1.

The significant advantage provided by the invention is that the increased length, and volume, of the passage between the extruder and cooling die allows the extrudate, which may be undergoing preliminary solidification, to maintain substantially unidirectional laminar flow. Therefore, the desirable structures that may be formed in the extrudate are not subjected to destructive turbulent flow, which would necessitate operating the extruder at inefficiently high temperatures, as outlined in the discussion on the prior art.

For example, for a given extrudate formulation, where a prior art system has been employed, the cooling die may be required to reduce extrudate temperature from 160° C. to less than 100° C., a reduction of greater than 60° C. However, utilising the invention, via for example a flow distribution device, fitted between an extruder and a multi-channel cooling die, the extrudate temperature at the extruder outlet may be run at 120° C. Therefore the cooling die is only then required to reduce the extrudate temperature by about 20° C. This effectively allows an increase in overall extrudate throughput of 200%, and will assist in reducing the incidence of product burning.

Preferably, the internal profile of the passage is substantially ovoid in cross-section. Even more preferably, the passage features an intermediate throat, wherein the maximum internal dimension at said throat is not greater than the minimum dimension of the extruder outlet. The particular advantage afforded by the throat feature is that it ensures that the flow path length, of any element of extrudate, from said throat to the entry point of any given extrudate channel in the cooling die is substantially the same. This in turn promotes very even, non-turbulent flow.

A particularly advantageous embodiment is provided where said passage is defined by the internal profile of a hollow connecting piece, said connecting piece including an extrudate entry orifice adapted for connection to the outlet of an extruder; an extrudate exit orifice adapted for connection to the inlet of a cooling die; and an extrudate transition portion disposed therebetween. The internal longitudinal cross-sectional profile of said transition portion being characterised by two zones: the first zone featuring, in profile, a smooth curvilinear transition from the approximate dimensions of the extruder outlet to a circular or ovoid throat of minimum diameter not greater than the minimum diameter of said extruder outlet; the second zone featuring, in profile, a smooth curvilinear expansion from said circular throat to the approximate dimensions of said cooling die inlet. A particular advantage of the smooth curvature of said internal surfaces is that they assist in reducing the incidence of flow ‘dead spots’, where turbulent flow can develop and which may also lead to product burning.

This profile assists in ensuring that the relative rate of flow of extrudate is evenly distributed to each of the channels, and evenly distributed within the channels, in the multi-channel cooling die. A particularly preferable embodiment is provided where a nose piece is disposed centrally on the inlet of said cooling die and inside said second zone such that it points toward said throat, and wherein said nose piece features an outer surface that is, in profile, approximately parallel with the inner surface of said second zone, thereby to force flowing extrudate to flow toward the individual cooling die inlet orifices in an annular channel of gradually expanding overall diameter but with approximately constant channel width. This embodiment further contributes to the objective that the effective flow path length for extrudate flowing from the throat to any individual cooling die channel be approximately equal, greatly promoting even distribution of extrudate flow amongst all said channels.

According to another aspect of the invention, there is provided an extruded food product produced via the facility of the flow distribution device described above.

According to another aspect of the invention, there is provided a food extrusion production line incorporating the flow distribution device described above.

### BRIEF DESCRIPTION OF THE DRAWINGS

Now will be described, by way of a specific non-limiting example, a preferred embodiment of the invention, with reference to the figures.

FIG. 1 shows a perspective view of a flow distribution device according to the invention, as viewed from the end which would be connected to the inlet of a circular cooling die.

FIG. 2 shows the flow distribution device of FIG. 1, viewed from the end that would be connected to the outlet end of a twin-screw extruder.

FIG. 3 shows the flow distribution device of FIG. 1, but with the inlet plate of said cooling die superimposed in position.

FIG. 4 shows a schematic cross-sectional view of a flow distribution device according to the invention, being connected to a twin screw extruder and a multi-channel cooling die.

### DETAILED DESCRIPTION OF THE INVENTION

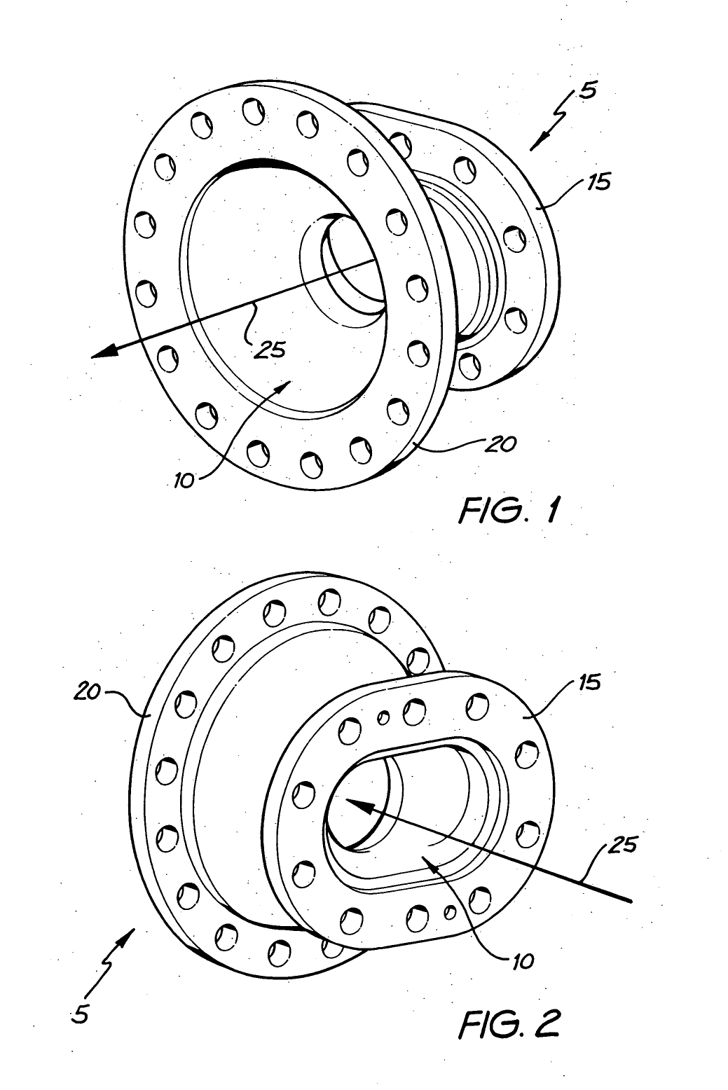

Turning first to FIG. 1, there is depicted a flow distribution device 5, consisting of an extrudate passage 10, defined by an internal surface of curvilinear profile, an extruder-connection flange 15 and a cooling die connection flange 20. It will be noted that, when in operation, extrudate 42 will enter the device 5 via the extruder connection flange 15, travel through the device 5 in the direction of the arrow 25 and will exit the device 5 and pass into the cooling die 50 via the cooling die connection flange 20. Turning to FIG. 2, the same features are shown from the opposite end of the device 5.

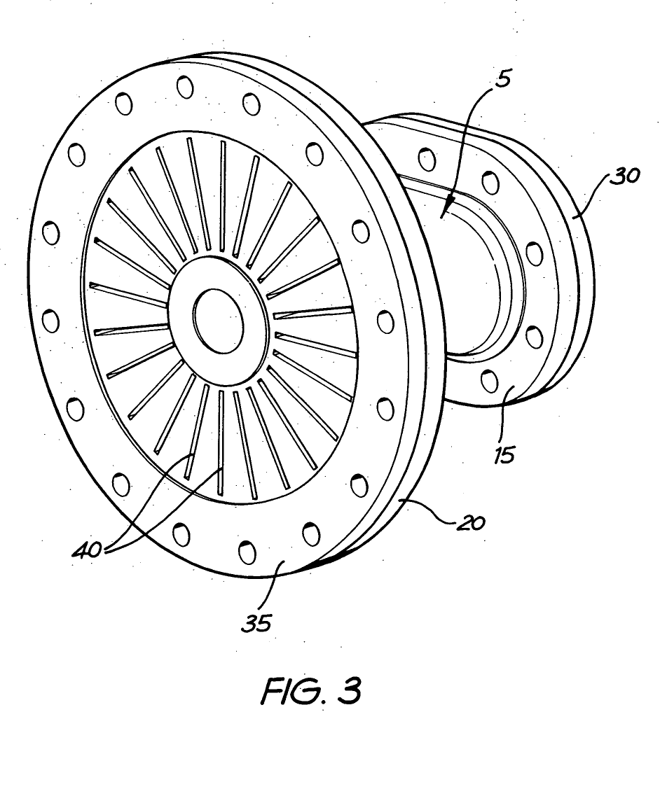

The flow distribution device 5, in practical operation, is directly connected to the outlet of a twin-screw conveying food extruder 45, for example of the type marketed by Buler AG, of 9240 Uzwil, Switzerland, via said extruder's outlet flange 30. It is similarly connected to a multi-channel cooling die 50, whose extrudate flow channels 40 are arranged radially about a circular axis, for example as disclosed in patent document no. WO 01/49474, via said cooling die's inlet flange 35. This attachment is partially indicated in FIG. 3, wherein the position of the extrudate flow channels 40 is also indicated.

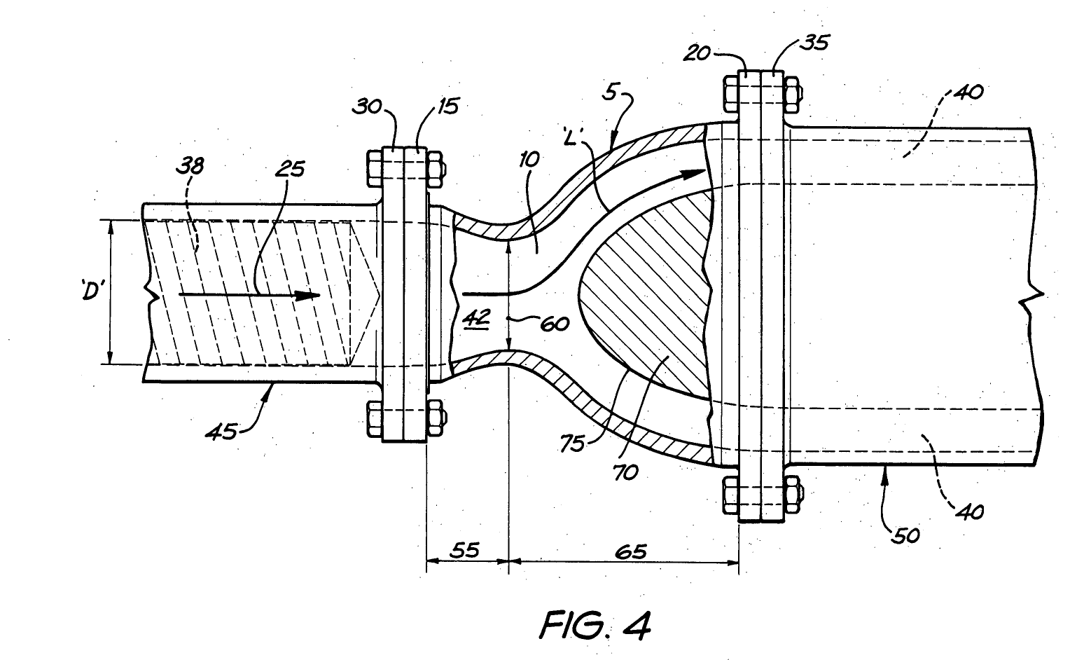

The cross-sectional view shown in FIG. 4 shows the structure of the device 5 and its essential operational features; in particular it's internal geometry. The device 5 is shown attached to a twin-screw extruder, having compression screws 38 of approximate diameter D, and to a multi-channel cooling die 50. The positions of the extrudate flow channels 40 are shown.

In particular, it will be noted that the length of the typical extrudate flow path L, relative to the diameter D, is greater than about 1.7:1. Those skilled in the art, and in particular those persons familiar with the flow of extrudate fluids, will perceive that the relative length of this flow path will greatly assist in the promotion of laminar flow of the extrudate 42 through the device 5 and on into the channels 40.

The device 5 is characterised by three main zones: a flow-restricting zone 55 of decreasing overall internal diameter in the direction of flow, and which also gradually transforms the internal profile of the device 5 from an ovular shape (matching the extruder outlet) to a substantially circular shape; a throat 60 of substantially circular profile, at which the minimum overall internal diameter is reached; and an expansion zone 65, in which the overall internal diameter increases (progressively less rapidly) in the direction of extrudate flow.

Extrudate 42 exiting the screws 38 of the extruder will tend to be engaged in turbulent flow. The throat 60 compresses this material and in so doing tends to reduce the relative turbulence of the flow. In addition, the transformation of the internal profile from ovular to circular tends to approximately equalise the flow path length of any element of extrudate 42 between the throat 60 and the cooling die 50, which assists in maintaining even, laminar flow and which helps to ensure an even radial distribution of flow to all of the cooling die extrudate channels 40.

A nose-piece 70 of approximately parabolic profile is placed inside the device 5, aligned with the device 5 centre-line. It is located at the centre of the inlet face of the cooling die 50. The overall external diameter of the surface 75 of the nose-piece 70 increases (progressively less rapidly) in the direction of extrudate flow. The effect of the shape and positioning of this nose-piece 70 is that the extrudate 42 is forced to flow through an annular channel, whose overall diameter increases in the direction of extrudate flow, but whose annular width remains substantially constant for at least a substantial portion of the expansion zone 65.

The practical effect of this arrangement is that the extrudate 42 flowing in the annular channel is greatly encouraged to adopt substantially laminar flow, as opposed to turbulent flow, with the attendant advantages for the formation of the desired texture in the final product.

In addition, it is preferred that the final annular width of the channel at the outlet of the device 5 is approximately equal to the height of the extrudate channels 40 in the cooling die 50, to further ensure that the laminar flow established in the device 5 is substantially maintained in the cooling die 50.

It will be apparent to those skilled in the art that the essential features of the invention may be embodied by many other physical configurations and that the above example is merely one such embodiment.

1. An extruder exit flow distribution device, for use in the transfer of high-moisture food extrudate material from an extruder to the inlet of a multi-channel cooling die, comprising:
an extruder having one or more extrusion screws;
a flow distribution device having an internal extrudate passage which defines a flow path for any given element of extrudate passing from the extruder exit to the entrance of said cooling dies;
wherein the ratio of the length of said extrudate flow path through said passage, to the length of the outer diameter of any one of the individual extruder screws, is greater than about 0.75:1.

2. The device of claim 1, wherein said ratio is greater than about 1.2:1.

3. The device of claim 2, wherein said ratio is greater than about 1.7:1.

4. The device of claim 1, wherein the internal profile of said passage is substantially ovoid in cross-section.

5. The device of claim 1, wherein said passage features an intermediate constriction in the flow path.

6. The device of claim 5, wherein the maximum internal dimension of said constriction is not greater than the minimum dimension of the extruder outlet.

7. The device of claim 6, wherein said passage is defined by the internal profile of a hollow connector, said connector including an extrudate entry orifice adapted for connection to the outlet of an extruder; an extrudate exit orifice adapted for connection to the inlet of a cooling die; and an extrudate transition portion disposed therebetween.

8. The device of claim 7, wherein said internal longitudinal cross-sectional profile of said transition portion comprises two zones: the first zone featuring, in profile, a smooth curvilinear transition from the approximate dimensions of the extruder outlet to a circular or ovoid constriction of minimum diameter not greater than the minimum diameter of said extruder outlet; the second zone featuring, in profile, a smooth curvilinear expansion from said circular constriction toward said cooling die inlet.

9. The device of claim 8, wherein a nose piece is disposed centrally on the inlet of said cooling die and inside said second section such that it points toward said constriction; and wherein said nose piece features an outer surface that is, in profile, approximately parallel with the inner surface of said second section, thereby to force flowing extrudate to flow toward the individual cooling die inlet orifices in an annular channel of gradually expanding overall diameter but with substantially constant channel width.

10. An extruded food product produced via the facility of an extruder exit flow distribution device, the device comprising:
an extruder having one or more extrusion screws;
a flow distribution device having an internal extrudate passage which defines a flow path for any given element of extrudate passing from the extruder exit to the entrance of said cooling die;
wherein the ratio of the length of said extrudate flow path through said passage, to the length of the outer diameter of any one of the individual extruder screws, is greater than about 0.75:1.

11. A production line for the production of extruded food, incorporating an extruder exit flow distribution device, the device comprising:
an extruder having one or more extrusion screws;
a flow distribution device having an internal extrudate passage which defines a flow path for any given element of extrudate passing from the extruder exit to the entrance of said cooling die;
wherein the ratio of the length of said extrudate flow path through said passage, to the length of the outer diameter of any one of the individual extruder screws is greater than about 0.75:1.

12. (Canceled)
